(19) United States
(12) Patent Application Publication
(10) Pub. No.: US 2024/0398660 A1
(43) Pub. Date: Dec. 5, 2024

(54) Novel Massager

(71) Applicant: Chuwen LIN, Guangdong (CN)

(72) Inventor: Chuwen LIN, Guangdong (CN)

(21) Appl. No.: 18/800,780

(22) Filed: Aug. 12, 2024

(51) Int. Cl. A61H 19/00; A61H 23/02

(52) U.S. Cl. CPC A61H 19/44; A61H 19/34; A61H 23/0254; A61H 2201/0153; A61H 2201/1215

(57) ABSTRACT

A novel massager comprises a stick body, wherein the stick body is divided into an intracorporal part and an extracorporeal part; wherein, the intracorporal part is provided with a convex movable part, and the movable part can be turned over back and forth to massage sensitive parts in the body; the stick body consists of an inner shell and an outer cladding, the outer cladding is wrapped on the outer surface of the inner shell, and the movable part is convexly arranged on the outer cladding; a driving device for driving the movable part to reciprocate is arranged in the inner shell; the driving device comprises an executing part, a driving part and a transmission part.

### TECHNICAL FIELD

The present invention relates to the technical field of massagers, in particular to a novel massager.

### BACKGROUND

Female massage stick, also known as masturbation stick or fun stick, is an adult product specially designed for women, mainly used for sexual masturbation and sexual stimulation. It mainly improves women's sexual interest by massaging the sensitive parts of women's bodies, thus improving the quality of sexual life.

The U.S. Pat. No. 9,254,238 discloses a kind of “Massage Device having Serial Vibrators”. The part of the massager in this patent that enters the human body is a polished rod, and it can only generate vibration massage, but cannot massage the sensitive parts in the female body (such as vaginal G-spot, etc.) independently.

Therefore, there is a need to propose a new type of massager. The new type of massager is additionally provided with a structure that can massage sensitive parts independently at the part where it enters the human body, and the structure can reciprocate, thus improving the massage effect of the massager and improving the quality of sexual life.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present invention provides a novel massager to solve that problem that the existing massager cannot massage the sensitive parts in the female body independently when entering the human body.

In order to achieve the above object, the present invention provides a novel massager, which includes a stick body, wherein
the stick body is divided into an intracorporal part and an extracorporeal part; and
wherein, the intracorporal part is provided with a convex movable part, and the movable part can be turned over back and forth to massage sensitive parts in the body;
the stick body is composed of an inner shell and an outer cladding, the outer cladding is wrapped on an outer surface of the inner shell, and the movable part is convexly arranged on the outer cladding;
a driving device for driving the movable part to reciprocate is arranged in the inner shell;
the driving device comprises an executing part, a driving part and a transmission part; and
wherein, the executing part is rotatably installed in the inner shell, and the executing part protrudes outward and is inserted into the movable part; and
wherein, the driving part can drive the transmission part to slide back and forth, and when the transmission part slides back and forth, the transmission part drives the executing part to turn over back and forth.

The present invention further provides a novel massager, which includes a stick body, wherein
the stick body is divided into an intracorporal part and an extracorporeal part; and
wherein, the intracorporal part is provided with a convex movable part, and the movable part can reciprocate and massage sensitive parts in the body;
the interior of the stick body is provided with a driving device for driving the movable part to reciprocate, and the driving device comprises an executing part and a driving part; and
wherein, the executing part is movably installed in the inner shell, and the executing part protrudes outwards and is inserted into the movable part; and
wherein, the driving part can drive the executing part to reciprocate, and when the executing part reciprocates, the executing part synchronously drives the movable part to reciprocate.

The present invention further provides a novel massager, which includes a stick body, wherein:
the stick body is divided into an intracorporal part and an extracorporeal part; and
wherein, the intracorporal part is provided with a convex movable part, and the movable part can reciprocate and massage sensitive parts in the body;
the interior of the stick body is provided with a driving device for driving the movable part to reciprocate, and the driving device comprises an executing part; and
wherein, the executing part is arranged inside the inner shell and can reciprocate inside the inner shell; and
wherein, the executing part protrudes outwards and is inserted into the movable part, and when the executing part reciprocates, the executing part synchronously drives the movable part to reciprocate.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic structural diagram of the whole invention.

FIG. 2 is a schematic structural view of the whole invention from another angle.

FIG. 3 is a sectional view of the whole invention.

FIG. 4 is a partially enlarged schematic view at A of FIG. 3 according to the present invention.

FIG. 5 is a schematic structural view of the inner shell of the present invention.

FIG. 6 is a schematic structural view of the inner shell of the present invention after disassembly.

FIG. 7 is a partially enlarged schematic view at B of FIG. 6 in accordance with the present invention.

FIG. 8 is a schematic structural diagram of the driving device of the present invention.

FIG. 9 is a schematic structural view of the driving device of the present invention from another angle.

Reference signs: Stick body (100); Intracorporal part (101); Extracorporeal part (102); Outer cladding (200); Movable part (201); Extension part (202); First opening (203); Inner shell (300); Second opening (301); Plate (401); Rotating shaft (402); Connecting part (403); First connecting groove (404); Gear motor (500); Eccentric shaft (501); Slider (600); Second connecting groove (601); Connecting shaft (602); Guide rod (603); Vibration motor (700); Storage battery (800); Circuit board (900); Control button (901).

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

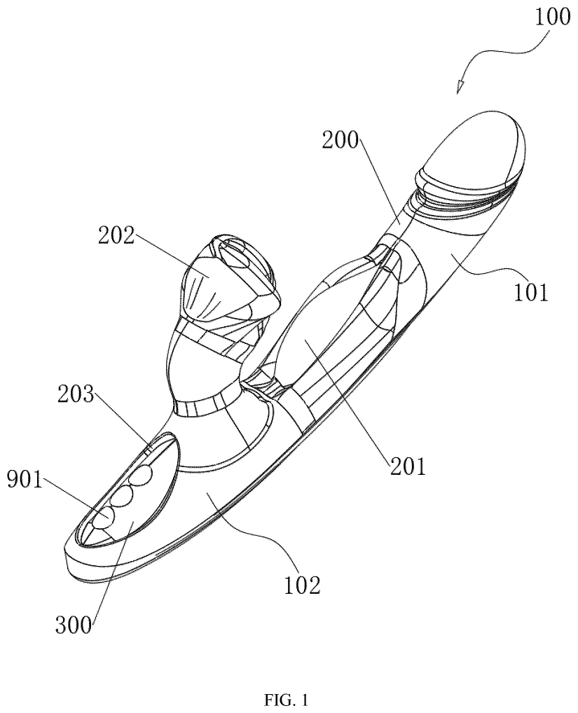

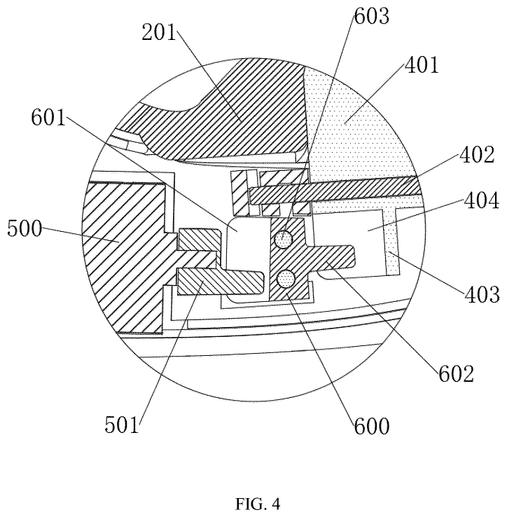

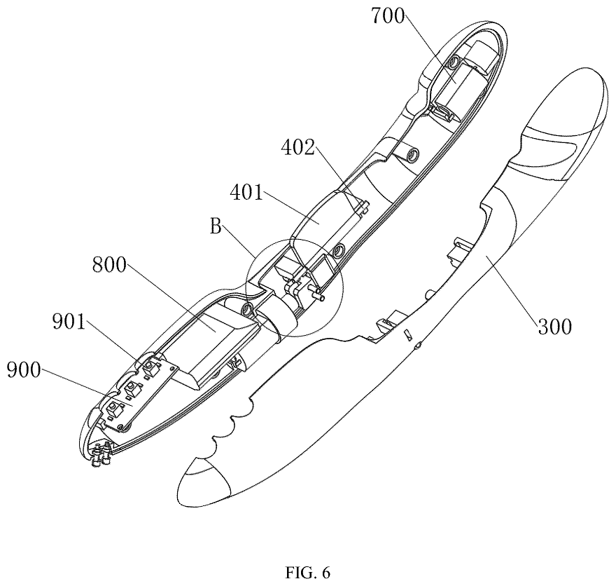

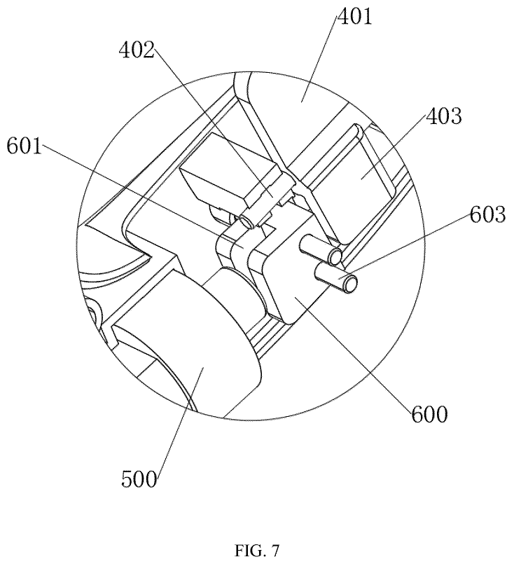

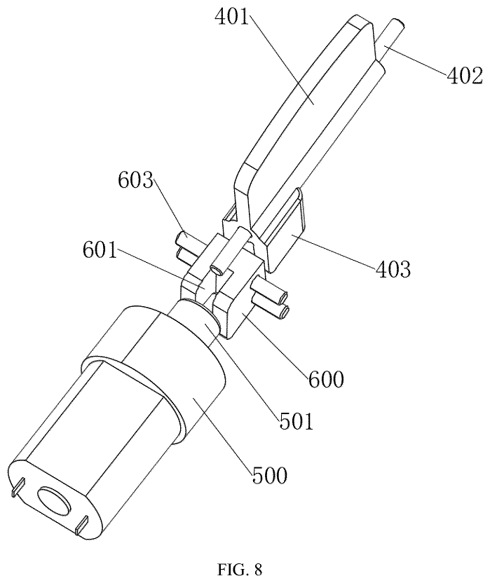

Please refer to FIG. 1 to FIG. 9:

The present invention provides a novel massager, which includes a stick body 100, wherein the stick body 100 is divided into an intracorporal part 101 and an extracorporeal part 102; the intracorporal part 101 is provided with a convex movable part 201, and the movable part 201 can be turned over back and forth to massage sensitive parts in the body.

In this embodiment, as shown in FIGS. 1 to 3, the position where the movable part 201 is arranged corresponds to the female vagina G point. Therefore, when the massager is used, the movable part 201 can additionally massage the vaginal G-spot, thereby increasing the stimulation to the human body, making the user more comfortable and easier to reach in orgasm.

Moreover, the movable part 201 is not limited to the above-mentioned position. In other embodiments of the movable part 201 (not shown in the figure), the movable part 201 can also be arranged at the position of stimulating other sensitive parts in the vagina, so that the user can choose massagers with different stimulating parts as required.

According to the above, the stick body 100 is composed of the inner shell 300 and the outer cladding 200. The outer cladding 200 covers the outer surface of the inner shell 300, and the movable part 201 is convexly arranged on the outer cladding 200. A driving device for driving the movable part 201 to move back and forth is provided in the inner shell 300. The driving device includes an executing part, a driving part and a transmission part. The executing part is rotatably installed in the inner shell 300, and the executing part protrudes outward and is inserted into the movable part 201. The driving part can drive the transmission part to slide back and forth, and when the transmission part slides back and forth, the transmission part drives the executing part to turn over back and forth.

In this embodiment, the outer cladding 200 is made of a flexible material, preferably a silicone material, and the movable part 201 is integrally formed with the outer cladding 200. Therefore, when the massager is used, the flexible outer cladding 200 is not easy to cause damage to some parts of the human body (such as vagina), which makes the user more comfortable to use. Through the arrangement of the inner shell 300, the massager can be ensured to have a certain hardness and the massage comfort can be improved.

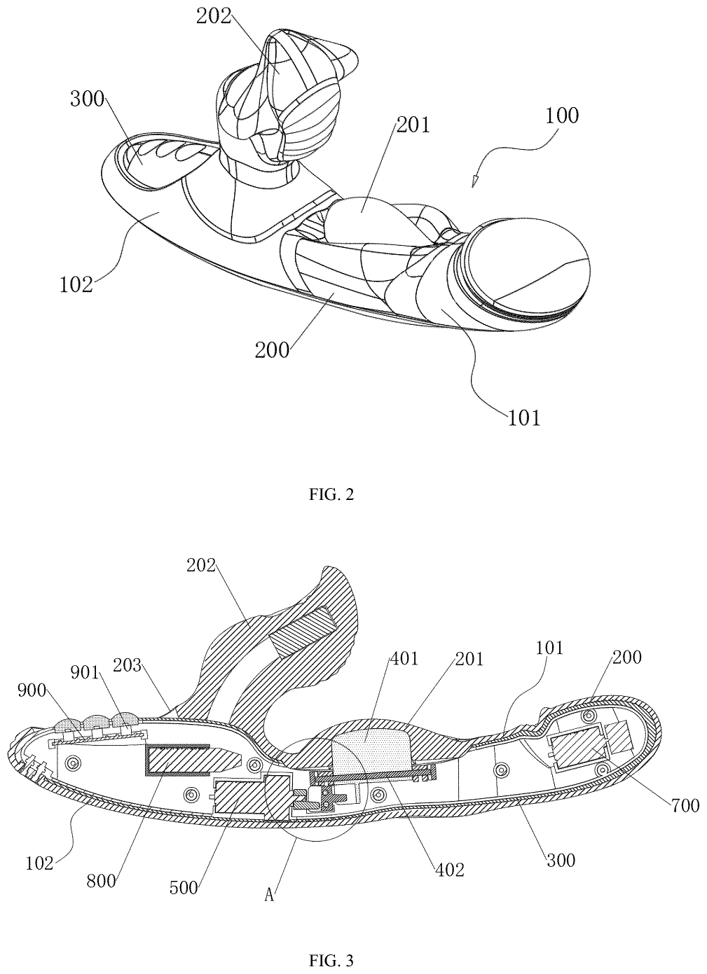

Moreover, in this embodiment, the periphery of the movable part 201 is additionally provided with convex parts. As shown in FIGS. 1 and 2, the stimulation to sensitive parts can be further increased through the additionally arranged convex parts, and the massage effect can be improved.

Moreover, in this embodiment, the transmission part can change the driving form of the driving part, so that the executing part can turn over back and forth. During the reciprocating turnover of the executing part, the movable part 201 is synchronously driven to reciprocate turnover. Therefore, the movable part 201 that turns back and forth can beat the sensitive parts of the human body, thereby stimulating the sensitive parts and improving the massage effect of the massager. In addition, during the flapping process of the movable part 201, there will be a slight impact between the movable part 201 and the human body and vibration, so it can also have a certain vibration massage function during the flapping massage process, thus further improving the massage effect.

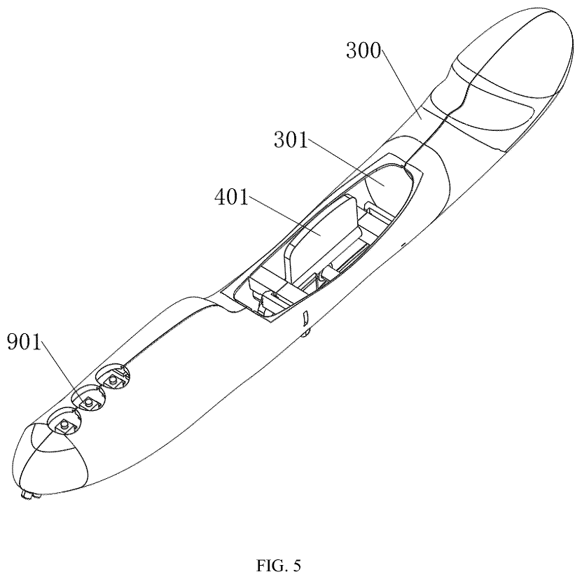

According to the above, in this embodiment, as shown in FIG. 5, the inner shell 300 is provided with a second opening 301 at the intracorporal part 101, and the second opening 301 is provided corresponding to the movable part 201. The executing part consists of a plate 401 and a rotating shaft 402. The rotating shaft 402 is inserted into the plate 401, and the end of the rotating shaft 402 passes through the plate 401 and is rotatably connected with the inner shell 300. The other end of the plate 401 extends out of the second opening 301 and is inserted into the movable part 201. The transmission part is a slider 600, and the driving part is a gear motor 500. The slider 600 is arranged between the gear motor 500 and the connecting part 403.

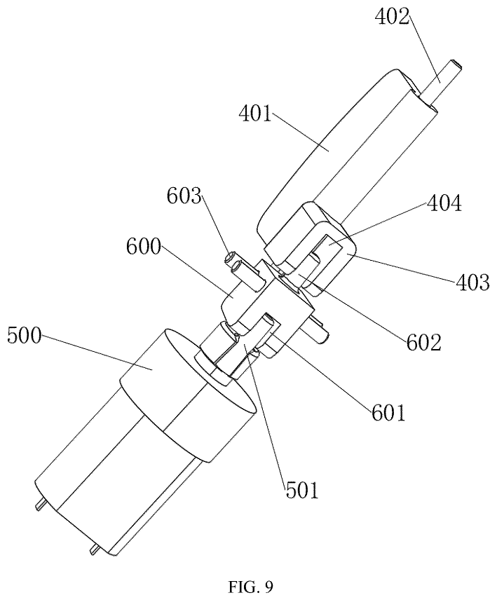

Please refer to FIG. 8 and FIG. 9. The preferred embodiment of the above structure is as follows: a plate 401 is provided with a connecting part 403 located inside the inner shell 300, and the connecting part 403 is internally provided with a first connecting groove 404. The transmission part is a slider 600, and the driving part is a gear motor 500. The slider 600 is arranged between the gear motor 500 and the connecting part 403. A second connecting groove 601 is provided at a side of the slider 600 facing the gear motor 500. A connecting shaft 602 is installed on a side of the slider 600 facing the plate 401. The connecting shaft 602 is inserted into the first connecting groove 404 and abuts against the inner wall of the first connecting groove 404. An eccentric shaft 501 is installed on the motor shaft of the gear motor 500. One end of the eccentric shaft 501 facing the slider 600 extends into the first connecting groove 404 and abuts against the inner wall of the first connecting groove 404. The slider 600 is inserted with a guide rod 603, which penetrates out of the slider 600 and is fixedly connected with the inner wall of the inner shell 300, and is slidably connected with the slider 600.

In this embodiment, the gear motor 500 can drive the eccentric shaft 501 to rotate. Because the eccentric shaft 501 is inserted into the second connecting groove 601, the eccentric shaft 501 has an eccentric structure, when the eccentric shaft 501 rotates, the rotating eccentric shaft 501 can push the slider 600 to slide back and forth on the guide rod 603. In the process of reciprocating sliding of the slider 600, the connecting shaft 602 of the slider 600 is inserted into the first connecting groove 404 of the connecting part 403. Therefore, the slider 600 that slides back and forth can push the connecting part 403 to move back and forth along the axial direction of the guide rod 603. Accordingly, when the connecting part 403 moves back and forth, the plate 401 will turn over back and forth around the rotating shaft 402. While the plate 401 that turns over back and forth synchronously drives the movable part 201 to turn over back and forth, so that the sensitivity in the human body can be patted and vibrated and massaged.

In other possible embodiments of the driving device (not shown in the figure), the driving part can also be an electric telescopic rod. The electric telescopic rod can automatically expand and contract after being electrified, and the power execution end of the electric telescopic rod is hinged or rotationally connected with the connecting part 403, so that the plate 401 can be pushed to turn over back and forth during the automatic expansion and contraction of the electric telescopic rod. In this way, the reciprocating flapping of the movable part 201 can also be realized.

Moreover, in other embodiments of the driving device (not shown in the figure), the driving part can also be a micro stepping motor, and the motor shaft of the micro stepping motor can rotate back and forth. The transmission part is a driving gear, and the driving gear thereof is connected with the motor shaft of a micro stepping motor. The rotating shaft 402 is correspondingly provided with a driven gear engaged with the driving gear. Therefore, when the micro stepping motor drives the driving gear to rotate back and forth, the rotating shaft 402 can also rotate back and forth, so that the plate 401 can also turn over back and forth. Further, the reciprocating flapping of the movable part 201 can be realized.

Therefore, by setting the driving device in different forms, in the actual processing and production process of massager, the required or appropriate driving mode can be selected according to the different shapes and sizes of products.

In this embodiment, the executing part drives the movable part 201 to move in a reciprocating manner. In other embodiments (not shown in the figure), the executing part can also be slidably arranged inside the inner shell 300, so that the executing part can reciprocate back and forth in a straight line. Its specific implementation is (not shown in the figure): the driving part is set as an electric telescopic rod, and the electric telescopic rod automatically expands and retracts and pushes the executing part to reciprocate back and forth in a straight line. The movable part 201 and the outer cladding 200 are separately arranged, so that the movable part 201 can reciprocate back and forth in a straight line with the executing part synchronously. Therefore, in this way, it is also possible to beat the sensitive parts in the body and improve the massage effect.

Of course, the movable part 201 reciprocates back and forth in a straight line, which is not limited to the above way. In other embodiments (not shown in the figure), the executing part is still slidably arranged inside the inner shell 300, and the driving part is a motor. At the same time, a transmission part is added between the executing part and the driving part, which can be a reciprocating screw with reciprocating threads. The reciprocating screw passes through the executing part and is connected with the executing part by threads, and the motor shaft of the motor is connected with the reciprocating screw. Therefore, when the motor rotates and synchronously drives the reciprocating screw to rotate, the rotating reciprocating screw can push the executing part to reciprocate back and forth in a straight line. Therefore, in this way, it is also possible to beat the sensitive parts in the body and improve the massage effect.

In this embodiment, the executing part has a flat structure. In other embodiments (not shown in the figure), the executing part can also be spherical, blocky or any other shape suitable for driving the movable part 201.

In this embodiment, as shown in FIGS. 1 to 3, the stick body 100 is located between the intracorporal part 101 and the extracorporeal part 102 and is provided with an extension part 202, which extends towards the intracorporal part 101 and is integrally formed with the outer cladding 200. Vibration motors 700 are installed in both the extension part 202 and the intracorporal part 101, and the extracorporeal part 102 is configured as a handle. A circuit board 900 and a storage battery 800 are installed inside the handle, and the storage battery 800 is electrically connected with the circuit board 900, and both the driver and the vibration motors 700 are electrically connected with the circuit board 900. A control button 901 is installed on the circuit board 900, and a first opening 203 is opened on the surface of the handle. The control button 901 penetrates through the inner shell 300 and is arranged in the first opening 203.

By arranging the vibration motor 700 in the intracorporal part 101 of the stick body 100, the intracorporal part 101 can perform vibration massage when the massager is used. In this way, the intracorporal part 101 of the stick body 100 has two functions of flapping massage and vibration massage, so that other sensitive parts in the human body can be massaged separately.

By providing the extension part 202, the vibration motor 700 is also provided in the extension part 202. When the massager is used, the extension part 202 can vibrate and massage sensitive parts outside the body (such as the clitoris of women).

By providing the storage battery 800, power can be supplied to the driver, the vibration motor 700 and the circuit board 900. The driving part and the vibration motor 700 can be controlled by the control button 901. The above contents belong to the prior art, and will not be repeated in detail herein in the present application.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A novel massager, comprising a stick body, wherein
the stick body is divided into an intracorporal part and an extracorporeal part; and
wherein, the intracorporal part is provided with a convex movable part, and the movable part can be turned over back and forth to massage sensitive parts in the body;
the stick body is composed of an inner shell and an outer cladding, the outer cladding is wrapped on an outer surface of the inner shell, and the movable part is convexly arranged on the outer cladding;
a driving device for driving the movable part to reciprocate is arranged in the inner shell;
the driving device comprises an executing part, a driving part and a transmission part; and
wherein, the executing part is rotatably installed in the inner shell, and the executing part protrudes outward and is inserted into the movable part; and
wherein, the driving part can drive the transmission part to slide back and forth, and when the transmission part slides back and forth, the transmission part drives the executing part to turn over back and forth.

2. The novel massager according to claim 1, wherein the outer cladding is made of a flexible material, and the movable part is integrally formed with the outer cladding.

3. The novel massager according to claim 1, wherein a second opening is arranged at the intracorporal part of the inner shell, and the second opening is provided corresponding to the movable part.

4. The novel massager according to claim 3, wherein the executing part is composed of a plate and a rotating shaft, the rotating shaft is inserted into the plate, and an end of the rotating shaft penetrates out of the plate and is rotatably connected with the inner shell.

5. The novel massager according to claim 4, wherein the end of the plate far from the rotating shaft extends out of the second opening and is inserted into the movable part.

6. The novel massager according to claim 4, wherein a connecting part located in the inner shell is arranged on the plate, and a first connecting groove is formed in the connecting part.

7. The novel massager according to claim 6, wherein the transmission part is a slider, the driving part is a gear motor, and the slider is arranged between the gear motor and the connecting part.

8. The novel massager according to claim 7, wherein a second connecting groove is formed on a side of the slider facing the gear motor, a connecting shaft is installed on a side of the slider facing the plate, and the connecting shaft is inserted into the first connecting groove and abuts against an inner wall of the first connecting groove.

9. The novel massager according to claim 8, wherein an eccentric shaft is mounted on a motor shaft of the gear motor, and one end of the eccentric shaft facing the slider extends into the first connecting groove and abuts against an inner wall of the first connecting groove.

10. The novel massager according to claim 7, wherein a guide rod is inserted into the slider, the guide rod penetrates out of the slider and is fixedly connected with an inner wall of the inner shell, and the guide rod is slidably connected with the slider.

11. A novel massager, comprising a stick body, wherein
the stick body is divided into an intracorporal part and an extracorporeal part; and
wherein, the intracorporal part is provided with a convex movable part, and the movable part can reciprocate and massage sensitive parts in the body;
the interior of the stick body is provided with a driving device for driving the movable part to reciprocate, and the driving device comprises an executing part and a driving part; and
wherein, the executing part is movably installed in the intracorporal part, and the executing part protrudes outwards and is inserted into the movable part; and
wherein, the driving part can drive the executing part to reciprocate, and when the executing part reciprocates, the executing part synchronously drives the movable part to reciprocate.

12. The novel massager according to claim 11, wherein the stick body is composed of an inner shell and an outer cladding, the outer cladding is wrapped on an outer surface of the inner shell, and the movable part is convexly arranged on the outer cladding.

13. The novel massager according to claim 12, wherein the stick body is provided with an extension part between the intracorporal part and the extracorporeal part, the extension part extends towards the intracorporal part, and the extension part is integrally formed with the outer cladding.

14. The novel massager according to claim 13, wherein vibration motors are installed inside the extension part and the intracorporal part, and the extracorporeal part is configured as a handle.

15. The novel massager according to claim 14, wherein a circuit board and a storage battery are installed inside the handle, the storage battery is electrically connected with the circuit board, and the driving part and the vibration motors are electrically connected with the circuit board.

16. The novel massager according to claim 15, wherein a control button is mounted on the circuit board, a first opening is formed on the surface of the handle, and the control button penetrates through the inner shell and is provided in the first opening.

17. A novel massager, comprising a stick body, wherein:
the stick body is divided into an intracorporal part and an extracorporeal part; and
wherein, the intracorporal part is provided with a convex movable part, and the movable part can reciprocate and massage sensitive parts in the body;
the interior of the stick body is provided with a driving device for driving the movable part to reciprocate, and the driving device comprises an executing part; and
wherein, the executing part is arranged inside the intracorporal part and can reciprocate inside the intracorporal part; and
wherein, the executing part protrudes outwards and is inserted into the movable part, and when the executing part reciprocates, the executing part synchronously drives the movable part to reciprocate.

18. The novel massager according to claim 17, wherein the driving device further comprises a driving part, and the driving part is used for driving the executing part to reciprocate.

19. The novel massager according to claim 18, wherein the driving device further comprises a transmission part, and the transmission part is used for changing the driving form of the driving part and driving the executing part to turn over back and forth.
